(19) United States
(12) Patent Application Publication
(10) Pub. No.: US 2025/0083195 A1
(43) Pub. Date: Mar. 13, 2025

(54) DECK SCRAPER

(71) Applicant: Jonathan Glenn Wall, Raleigh, NC (US)

(72) Inventor: Jonathan Glenn Wall, Raleigh, NC (US)

(21) Appl. No.: 18/462,479

(22) Filed: Sep. 7, 2023

(51) Int. Cl. B08B 1/00; A01D 34/00; B25G 1/10

(52) U.S. Cl. CPC B08B 1/165; A01D 34/003; B25G 1/102

(57) ABSTRACT

A scraper for removing debris from the bottom deck of a lawnmower is disclosed. The scraper has a serrated blade at a distal end of an elongated handle and straight edge blade on a first and second side of the serrated teeth blade.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a lawn mower deck scraper.

### Description of Related Art

The bottom deck of a rotary lawn mower builds up a great deal of debris. This debris tends to harden and build up thickness on the bottom deck, so over time, debris interferes with the use of the lawn mower and must be removed to continue to use the lawn mower.

The standard tools used to remove lawn mower deck debris are screwdrivers, putty knives, and paint scrapers, all having a flat straight edge and relatively short handle portions. Given enough time, much of the debris can be removed, but not without a great deal of effort and risk of injury due to a short handle near the lawn mower blades. However, even with great effort it is difficult, if not impossible, to remove all the debris with the standard tools. It is clear that a tool that can efficiently, safely, and quickly remove debris from the bottom deck of the lawn mower is needed.

### BRIEF SUMMARY OF THE INVENTION

The present invention relates to a novel design for a lawn mower deck scraper which includes a flat portion with serrated teeth instead of a straight edge positioned at the distal end of the scraper. It also includes perpendicular wings on each side of the serrated teeth with each wing having a straight edge. The scraper is more efficient and more effective at removing debris for a lawn mower deck. With a longer handle it is much safer than current tools

Accordingly, in one embodiment, there is a deck scraper for cleaning the bottom deck of a lawnmower comprising:
a) an elongated handle;
b) a blade positioned at the distal end of the handle, the blade having serrated teeth and a first side and a second side;
c) a pair of wings position with one wing on the first side and another wing on the second side and perpendicular to the serrated teeth blade each wing having a straight edge blade.

### BRIEF DESCRIPTION OF THE DRAWINGS

FIG. 1 is a perspective view of the deck scraper of the present invention.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

It is further noted that the claims may be drafted to exclude any element which may be optional. As such, this statement is intended to serve as antecedent basis for use of such exclusive terminology as “solely”, “only” and the like in connection with the recitation of claim elements, or the use of a “negative” limitation.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. To the extent such publication may set out definitions of a term that conflict with the explicit or implicit definition of the present disclosure, the definition of the present disclosure controls.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “deck scraper” refers to a scraper which can be used to clean the bottom deck or underside of a lawnmower in the area where the lawnmower blades rotate, scraping the deck scraper against the surface of the bottom deck to remove stuck on debris. The scraper can be made of hard plastic, metal or a combination of the two. In one embodiment the elongated handle is plastic and the blades are metallic.

As used herein, the term “bottom deck of a lawnmower” refers to the underside of the lawnmower deck in the area where the lawnmower blades rotate. This area is where debris buildup occurs and must periodically be removed.

As used herein, the term “elongated handle” refers to a handle of sufficient length that a user's hand is not near the blades when cleaning the bottom deck. This greatly reduces the chance of the lawnmower blade coming in contact with the user's hand. The exact length will depend on the size of the lawnmower blades. In one embodiment the elongated handle is from about at least 9 inches. In one embodiment it is 11.75 inches.

As used herein, the term “blade” refers to the scraping edge of the deck scraper positioned at the distal end of the elongated handle and also the blade edge of the perpendicular wings attached to the scraping edge. The distal end blade has a serrated edge while the wings have a straight edge. The figures exemplify the positioning of the blades used in the deck scraper. In general in one embodiment the serrated teeth blade is 4 inches wide.

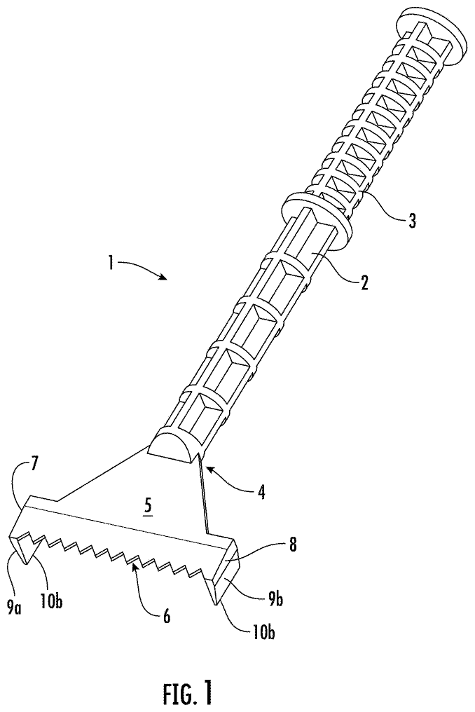

As used herein, the term “serrated teeth” refers to having or denoting a jagged edge; i.e., saw like teeth as seen in FIG. 1. While a straight edge as on a putty scraper is used on the wings as also seen in FIG. 1.

As used herein, the term “pair of wings” refers to a blade positioned perpendicular to the serrated teeth blade. There is one wing positioned at a first and second end of the serrated teeth blade. The end of the wing distal to the serrated teeth blade have a straight edge blade. In general, the wings are from about 0.5 to 0.75 inches long. The advantage of the wings is to provide an adjacent cleaning path at the vertical/horizontal juncture of the mower deck. The user has the ability to use his/her right hand or left hand, depending on the mower deck orientation at the time of cleaning.

As used herein, the term “debris” refers to grass, dirt mud and the like that is thrown from the lawnmower blades to the bottom deck where it attaches and usually hardens necessitating a tool to remove the debris.

### DRAWINGS

Now referring to the drawing, FIG. 1 is a perspective view of the deck scraper 1 of the present invention. Elongated handle 2 has gripping surface 3 design to provide a better grip. At the distal end 4 of the elongated handle there is blade 5 which has serrated teeth 6. At a first end 7 and second end 8 of the blade 5 is positioned perpendicular wings 9a and 9b wherein each of the wings (blades) has a straight edge 10a and 10b.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A deck scraper for cleaning the bottom deck of a lawnmower comprising:
a) an elongated handle;
b) a blade positioned at the distal end of the handle, the blade having serrated teeth and a first side and a second side;
c) a pair of wings position with one wing on the first side and another wing on the second side and perpendicular to the serrated teeth blade each wing having a straight edge blade.

2. The deck scraper according to claim 1 wherein the elongated handle has a gripping surface.
